(19) United States
(12) Patent Application Publication
(10) Pub. No.: US 2007/0254111 A1
(43) Pub. Date: Nov. 1, 2007

(54) Method for forming a tribologically enhanced surface using laser treating

(76) Inventors: Warran B. Lineton, Ann Arbor, MI (US); Miguel Azevedo, Ann Arbor, MI (US); Geoffrey Neil Ainsworth, Ann Arbor, MI (US); Jason Henderlong, Pinckney, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/411,300

(22) Filed: Apr. 26, 2006

(51) Int. Cl. B05D 3/00

(52) U.S. Cl. 427/554

(57) ABSTRACT

The invention provides a method for forming a tribologically enhanced surface on a work-piece. The method includes the step of combining a predetermined material operable to enhance tribological properties with a liquid to form a slurry or a solution. The method also includes the step of applying the slurry/solution to a surface of a work-piece. The method also includes the step of transforming the phase of the predetermined material with a laser after the applying step. Transforming the phase of the predetermined material generates a chemical reaction binding the tribological agent with the surface of the work-piece.

### BACKGROUND OF THE INVENTION

1. Field of the Invention

The invention relates to laser treatment of metal.

2. Description of Related Art

Lasers can rapidly heat a surface of a work-piece for adjusting properties of the surface. An absorptive coating can be applied to the surface to be heated to enhance the energy transfer from the laser to the work-piece. By using a laser to quickly heat a surface, conventional quenching by a gas or a liquid is unnecessary since only the shallow surface layer is heated. The part will actually self-quench, due to the extremely high heat differential between the surface layer heated by the laser and the remainder of the work-piece. This is in sharp contrast to carburizing or induction heating, where the part must be heated in one operation, and then is required to be quickly quenched by a gas or a liquid. Laser radiation can be generated by CO₂, Excimer or Nd—YAG lasers, diode lasers; some of these lasers can achieve intensities of more than 10⁶ watt/cm².

### SUMMARY OF THE INVENTION

The invention provides a method for forming a tribologically enhanced surface on a work-piece. The method includes the step of combining a predetermined material operable to enhance tribological properties with a liquid to form a slurry or a solution. The method also includes the step of applying the slurry/solution to a surface of a work-piece. The method also includes the step of transforming the phase of the predetermined material with a laser after the applying step. Transforming the phase of the predetermined material generates a chemical reaction binding the tribological agent with the surface of the work-piece.

### BRIEF DESCRIPTION OF THE DRAWINGS

Advantages of the present invention will become more readily appreciated when considered in connection with the following detailed description and appended drawings, wherein:

FIG. 1 is a simplified flow diagram of the exemplary embodiment of the invention; and

FIG. 2 is a schematic view of the laser treatment of the exemplary embodiment of the invention.

### DETAILED DESCRIPTION OF THE PREFERRED EMBODIMENT

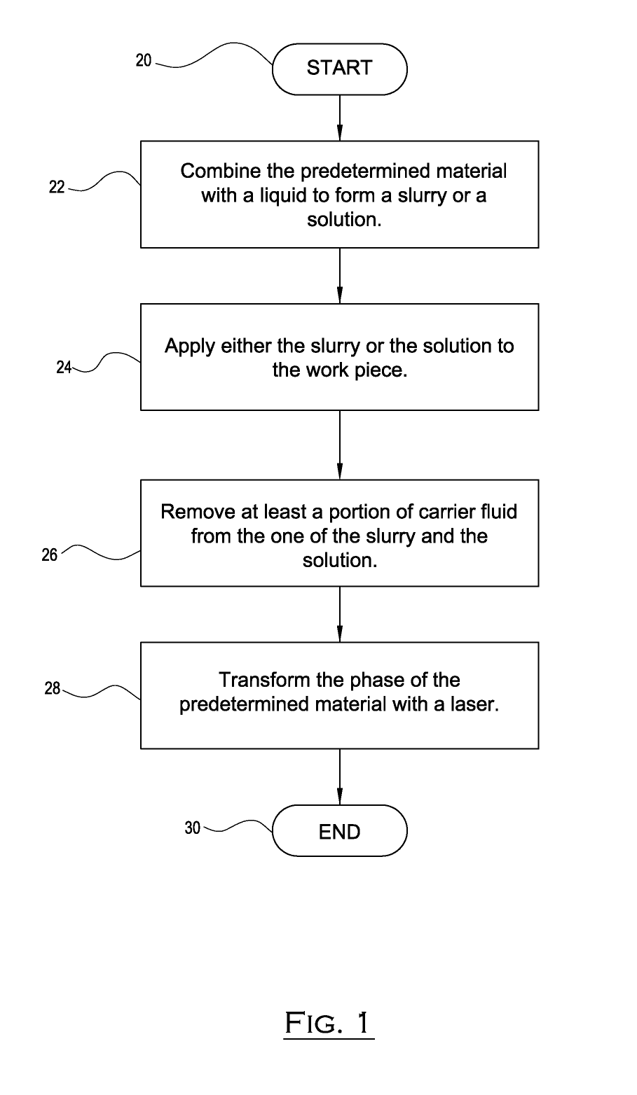

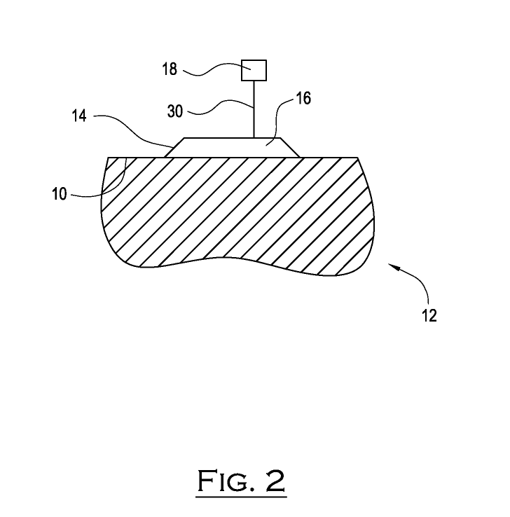

A process according to the exemplary embodiment of the invention is shown in FIGS. 1 and 2. The process starts at step 20. At step 22, a predetermined material 14 operable to enhance tribological properties is combined with a liquid to form a slurry or a solution 16. Generally, a slurry is a mixture of insoluble material in a liquid and a solution is a mixture of a soluble material in a liquid. For clarity, only a slurry is described below, but the invention is not limited to a slurry. The predetermined material 14 can be selected as a form of sulfur, as a form of chlorine, or as a form of phosphorous. For example, the predetermined material 14 can be iron phosphate, manganese phosphate, sulfur powder, iron chloride, dichloro dicetyl selenium dichloride, or octadecyl chloride. The liquid is selected for having low reactivity with the surface 10 of the work-piece 12 and the predetermined material 14 during the melting step which is described in greater detail below. The liquid can be an organic solvent or aqueous carrier in combination with a binding agent when the predetermined material is insoluble with respect to the liquid. In the exemplary embodiment of the invention, the binding agent is polyvinyl alcohol. In alternative embodiments of the invention, the binding agent could be shellac or a low melting point wax.

At step 24, the slurry 16 is applied to the surface 10 of the work-piece 12. An amount of the slurry 16 can be applied to ensure that a sufficient amount the predetermined material 14 covers the surface. For example, it may be desirable to apply the slurry 16 such that 0.9 milligrams of the predetermined material 14 are disposed per square centimeter of the surface 10. The slurry 16 can be applied by any suitable method, such as by brush painting, screen printing, dipping, spraying, or ink jet printing.

The work-piece 12 can be formed from steel. Prior to step 24, the process could also include the step of ensuring that the work piece has a defined surface texture for example by grinding, polishing or lapping.

At step 26, at least a portion of the aqueous or carrier medium is removed from the slurry 16. In the exemplary embodiment of the invention, the work-piece 12 can be disposed in a convection oven and the slurry 16 can be at least partially dried. The invention can be practiced wherein all of the carrier medium is removed from the slurry 16, leaving only the predetermined material 14 and if present binding agent operable to enhance the tribological properties of the surface 10.

At step 28, a phase of the predetermined material 14 is changed with a laser 18. The phase change can be defined by melting or by vaporizing or by plasma generation. The diode laser 18 directs beam 30 at the predetermined material 14. The predetermined material 14 wets the surface 10 and chemically reacts with the surface 10. As a result of the chemical reaction, a tribological layer is formed on the surface 10. Tribology is the science of the mechanisms of friction, lubrication, and wear of interacting surfaces that are in relative motion. Tribology is a branch of engineering that deals with the design of parts to control friction and wear. The enhanced tribological surface refers to the fact that the surface 10 will experience more controlled friction and less wear in operation compared with an untreated part after the process of the invention is performed. The laser 18 can be a line-focused source such as a diode laser. The laser 18 can preferably sweep over a large area.

The process of the invention can reduce and/or eliminate the need for chemical baths that can be costly and/or environmentally detrimental to operate. The process of the invention can also reduce and/or eliminate the need for extreme pressure additives to be included with lubricants in the operating environment of the work-piece 12. Extreme pressure additives may be highly toxic. The process of the invention can produce a stable tribological layer without the need for post-processing or finishing. The process ends at step 32.

Many modifications and variations of the present invention are possible in light of the above teachings. It is, therefore, to be understood that within the scope of the appended claims, the invention may be practiced otherwise than as specifically described.

What is claimed is:

1. A method for forming a tribologically enhanced surface on a work-piece comprising the steps of:
combining a predetermined material operable to enhance tribological properties with a liquid to form one of a slurry and a solution;
applying the one of the slurry and the solution to a surface of a work-piece; and
transforming a phase of the predetermined material with a laser after said applying step to generate a chemical reaction binding the predetermined material with the surface of the work-piece.

2. The method of claim 1 further comprising the step of:
selecting a form of sulfur as the predetermined material.

3. The method of claim 1 further comprising the step of:
selecting a form of chlorine as the predetermined material.

4. The method of claim 1 further comprising the step of:
selecting a form of phosphorous as the predetermined material.

5. The method of claim 1 further comprising the step of:
reducing a volume of the one of the slurry and the solution on the surface prior to said transforming step.

6. The method of claim 1 further comprising the step of:
selecting the liquid for having low reactivity with the surface of the work-piece during said transforming step.

7. The method of claim 6 wherein said selecting step is further comprises the step of:
selecting polyvinyl alcohol and an aqueous medium to form the liquid.

8. The method of claim 7 further comprising the step of:
reducing a volume of the one of the slurry and the solution on the surface prior to said transforming step by reducing an amount of the aqueous medium.

9. The method of claim 1 wherein said transforming step is further defined as:
melting the predetermined material with the laser.

10. The method of claim 1 wherein said transforming step is further defined as:
vaporizing the predetermined material with the laser.

11. The method of claim 1 wherein said transforming step is further defined as:
converting the predetermined material to a plasma with the laser.

12. A method for forming a tribologically enhanced surface on a work-piece comprising the steps of:
combining a predetermined material operable to enhance tribological properties and selected from the group comprising iron phosphate, manganese phosphate, sulfur powder, iron chloride, dichloro dicetyl selenium dichloride, or octadecyl chloride with a liquid selected from the group comprising polyvinyl alcohol solution, shellac and a low melting point wax to form one of a slurry and a solution;
applying the one of the slurry and the solution to a surface of a work-piece by one of brush painting, screen printing, dipping, spraying, and ink jet printing; and
transforming a phase of the predetermined material through one of melting, vaporizing and generating plasma with a laser after said applying step to generate a chemical reaction binding the predetermined material with the surface of the work-piece.
